(19) United States
(12) Patent Application Publication
(10) Pub. No.: US 2003/0098121 A1
(43) Pub. Date: May 29, 2003

(54) Patterned porous structures

(76) Inventor: Wilson Moya, Concord, MA (US)

Correspondence Address: MILLIPORE CORPORATION, 290 CONCORD ROAD, BILLERICA, MA, 01821, US

(21) Appl. No.: 10/314,780

(22) Filed: Dec. 9, 2002

Related U.S. Application Data
(62) Division of application No. 09/661,920, filed on Sep. 14, 2000.
(60) Provisional application No. 60/166,152, filed on Nov. 17, 1999.

(51) Int. Cl. B32B 31/00

(52) U.S. Cl. 156/275.1; 156/290

(57) ABSTRACT

The present invention is a porous structure formed with areas of porous material and areas of reduced porosity or non-porous material. Preferably, the structure is formed in the arrangement of a desired pattern of porous and reduced porosity or non-porous areas. The patterned structure is formed through the collapse of selected portions of the porous structure in the shape of the desired pattern to render these portions of reduced porosity or non-porous while the remaining portions of the structure remain porous. The use of heat and/or pressure is preferred to collapse the selected areas. The collapse may be aided by the use of a softening solvent or solvent/non-solvent mixture. The process can be applied to any polymeric porous structure of any pore size such as ultrafiltration or microfiltration, made by any process such as by track etch, stretching, casting, sintering or extrusion. In addition, it may be used with woven or nonwoven fabrics.

The porous/reduced porosity or non-porous structure may be used alone or in conjunction with other layers, such as additional layers of porous structures, porous support layers, any of which may either containing corresponding porous/reduced porosity or non-porous regions or not, or reduced porosity or non-porous support layers such as films or plastics, which may having openings corresponding to the porous regions of the structure such as multiple well plates or cards.

This application relates to co-pending US patent applications “Three Dimensional Patterned Porous Structures,” U.S. S No. 60/154,564 filed Sep. 17, 1999; “High Throughput Templateing Card,” U.S. S No. 60/154,565, filed Sep. 17, 1999; and “Patterned Porous Structures”, U.S. S No. 60/154,630, filed Sep. 17, 1999.

The present invention is related to porous structures having selected functional patterns upon and/or in them. More particularly, it relates to porous structures such as membranes, formed as one or more layers that have a series of one or more patterns of porous and reduced porosity or non-porous areas in one or more layers of the structure.

### BACKGROUND OF THE INVENTION

Patterned porous structures have been known. In particular, patterned porous membranes have been used to create membranes having hydrophilic areas separated from each other by a grid like pattern of hydrophobic areas. These membranes have been useful in diagnostic applications and in the collection, culturing, enumeration and identification of microorganisms. These porous regions can serve the functions of filtration, separation by absorption or adsorption, or as small individual reaction vessels, or other functions requiring small, high surface area volumes. The regions can be chemically modified by methods known in the art such as by methods disclosed in U.S. Pat. No. 5,629,084, which is incorporated herein by reference.

U.S. Pat. No. 5,271,839 teaches a process for forming patterns in porous structures. It uses an otherwise non-porous polymeric material which has the desired pattern masked off. It then contacts that material with a solvent that gels the exposed surfaces. The gelled material is then precipitated by exposure to a non-solvent for the polymeric material thereby forming porous structures within the polymeric material in the form of the pattern while the masked areas remain non-porous. The final product is recovered following removal of the mask.

U.S. Pat. No. 5,627,042 teaches a surface modification method in which the surface of a hydrophobic membrane is coated with a crosslinked hydrophilic polymer in the shape of a pattern. The entire membrane is first contacted with an appropriate monomer or monomers for hydrophilic coating. Subsequently the hydrophilic pattern is formed by UV initiated polymerization and crosslinking of the monomers in selected areas of the membrane by exposing portions of the membrane to the light while masking the other portions from exposure to the light. This process results in a membrane having patterned hydrophilic portions in the areas exposed to the UV light and hydrophobic portions in the area masked from the UV light.

Both of these processes have limitations. For example, the method of the '839 patent is limited in to certain combinations of solvents, polymers, and non-solvents which will give the desired porosity. Additionally, some well-known polymeric materials such as PTFE resin are difficult or impossible to solvate and therefore not suitable for the process. Even where a solvent is available, many of these solvents are extremely flammable or toxic making their use difficult and or prohibitive. Precise control of the porous regions is difficult, particularly for very small regions required for microchemistry applications, because of lateral diffusion of the solvent in the polymer material during polymer-solvent contact.

Likewise, the process of the '042 patent is limited in its ability to form such structures due to the required UV absorbing characteristics of the selected polymers and/or monomers or the relative ability of the structures to retain the hydrophilic or hydrophobic characteristics. In addition this process does not produce a pattern of porous regions separated by reduced porosity or non-porous regions, but of porous hydrophilic regions separated by porous hydrophobic regions or ways. The porous hydrophobic ways can cause cross contamination between the porous hydrophilic regions if the liquid has some wetting potential and is contacted for sufficient time.

The present invention provides a new method for forming a porous structure containing one or more selected patterns, which is applicable to all porous structures regardless of their polymeric content, their method of manufacture or their UV absorbing characteristics.

### SUMMARY OF THE INVENTION

The present invention is a porous structure formed with areas of porous material and areas of reduced porosity or non-porous material. Preferably, the structure is formed in the arrangement of a desired pattern of porous and reduced porosity or non-porous areas. The patterned structure is formed through the collapse of selected portions of the porous structure in the shape of the desired pattern to render these portions with reduced porosity or non-porous while the remaining portions of the structure remain porous. The use of heat and/or pressure is preferred to collapse the selected areas. The collapse may be aided by the use of a softening solvent or solvent/non-solvent mixture. The process can be applied to any polymeric porous structure of any pore size such as ultrafiltration or microfiltration, made by any process such as by track etch, stretching, casting, sintering or extrusion. It may be a single layer or multiple layered system formed either simultaneously or sequentially. In addition, it may be used with woven or nonwoven fabrics.

It is an object of the present invention to provide a process for forming a pattern of porous and reduced porosity or non-porous areas on a porous structure comprising the steps of: selecting one or more layers of a porous structure, forming a pattern template containing the selected pattern for the areas of porous and reduced porosity or non-porous areas, said template is formed of a solid material having a series of openings in the shape and arrangement desired and which correspond to the porous areas and applying a energy selected from the group consisting of heat, pressure, softening chemical and combinations thereof to the areas of the structure aligned with the solid portion of the template in order to cause the porous structure beneath the solid portion of the template to collapse and become fused into a reduced porosity or non-porous mass while leaving the porous areas within the openings unaffected and porous.

It is another object to provide a patterned porous structure comprising a porous structure of one or more layers having one or more areas of porous material and one or more areas of reduced porosity or non-porous material.

It is a further object to provide a patterned porous structure comprising a porous structure having one or more areas of porous material and one or more area of reduced porosity or non-porous material wherein the areas of porous material are arranged in a manner so as to be separate and distinct from each other and separated by a reduced porosity or non-porous structure.

It is an additional object to provide a patterned porous structure comprising a porous structure having one or more areas of porous material and one or more areas of reduced porosity or non-porous material wherein the one or more areas of porous material are of a shape selected from the group consisting of circles, ovals, polygons, lines and mixtures thereof.

Another object is to provide a patterned porous structure comprising a porous structure having one or more areas of porous material and one or more areas of reduced porosity or non-porous material wherein the one or more areas of porous material are at least 96 in number, equal in size and arranged in rows relative to each other in both the X and Y direction.

A further object is to provide a patterned porous structure comprising a porous structure having one or more areas of porous material and one or more areas of reduced porosity or non-porous material wherein the porous material has a concave and a convex side.

Another object is to provide a patterned porous structure comprising a porous structure having one or more areas of porous material and one or more areas of reduced porosity or non-porous material which is supported by a support layer which may be porous or reduced porosity or non-porous and may have the same arrangement of porous and reduced porosity or non-porous areas or not.

An additional object is to form a porous structure having one or more areas of reduced porosity or non-porous material which support and strengthen the remainder of the structure.

A further object is to provide a patterned porous structure comprising a porous structure having one or more areas of porous material and one or more areas of reduced porosity or non-porous material wherein the porous material form a series of channels connecting a series of pads or large porous areas.

Another object is to provide a patterned porous structure comprising a porous structure having one or more areas of porous material and one or more areas of reduced porosity or non-porous material wherein the structure has been surface modified either before or after the formation of the porous/reduced porosity or non-porous areas.

These and other objects will be readily discernable from the teachings of the specification and claims below.

### BRIEF DESCRIPTION OF THE DRAWINGS

FIG. 1 shows a first embodiment of the present invention in planar view.

FIG. 2 shows a second embodiment of the present invention in planar view.

FIG. 3 shows another embodiment of the present invention in cross sectional view.

FIG. 4 shows a further embodiment of the present invention in cross sectional view.

FIG. 5 shows an embodiment of the present invention in planar, top down view.

FIG. 6 shows an embodiment of the present invention in cross sectional view.

FIG. 7 shows an embodiment of the present invention in cross sectional view.

FIG. 8 shows an embodiment of the present invention in planar view.

FIG. 8A shows an alternative, multilayered embodiment to FIG. 8 in cross sectional view.

FIG. 9 shows an embodiment of making the present invention in cross sectional view.

FIG. 10 shows another embodiment of making the present invention in cross sectional view.

### DETAILED DESCRIPTION OF THE INVENTION

The basic premise of the present invention is to take a porous structure and selectively collapse portions of that structure in the shape of a desired pattern so as to render those areas with reduced porosity or non-porous while the remaining portions of structure remain porous.

It is well known that porous structures, such as membranes are susceptible to collapse due to their inherent high surface area and porosity that results in an internal structure which is inherently weak due to the small amount of supporting structure holding the membrane together. Membrane collapse occurs when a membrane is subjected to a mechanical force and/or thermal energy thereby causing the supporting structure of the membrane, which typically amounts to about between 10% and 50% of the volume of the membrane (the rest being air), to collapse and become irreversibly fused into a dense reduced porosity or non-porous mass.

Generally, membrane collapse is highly undesirable because it reduces the effective porous structure area available for its intended use such as filtration. However, it has now been found that the controlled collapse of selected areas of porous structure can be beneficial in certain applications such as in the filtration and/or immobilization of biomolecules in the biotechnology industry or in microfluidics applications such as in laboratory-on-a-chip or biochip technologies. This is particularly true when the collapsed areas are formed in a desired pattern.

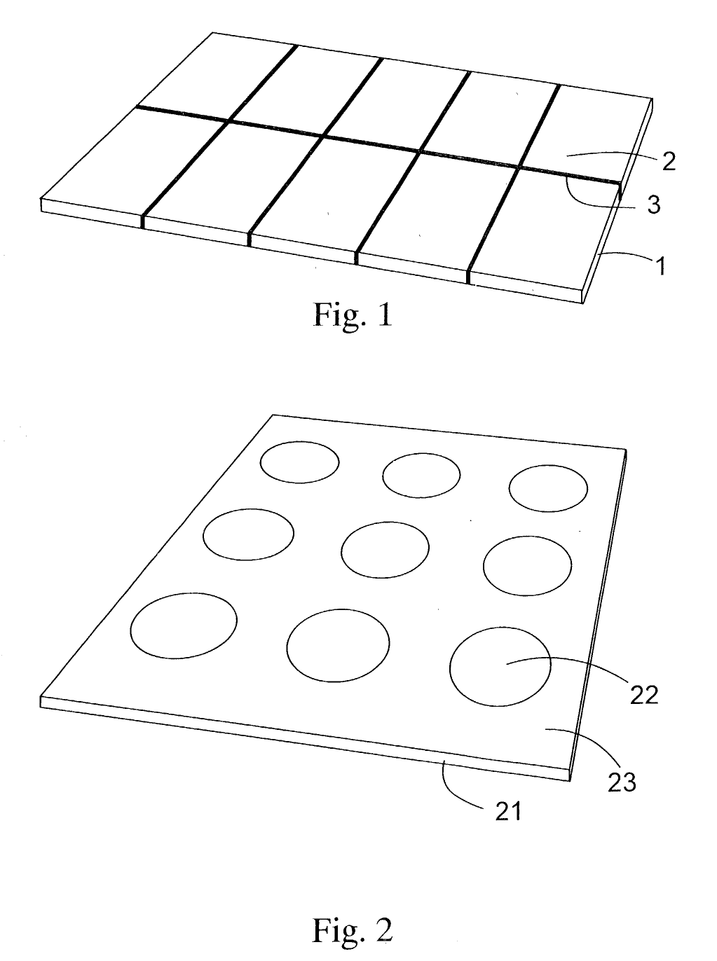

In FIG. 1 is shown as first embodiment of the present invention. As shown, there is a structure, in this case a porous porous structure 1 that has one or more areas of porous materials 2 and one or more reduced porosity or non-porous areas 3. In this arrangement, the reduced porosity or non-porous areas 3 are formed as a series intersecting lines that form a series of square grids, the interior of each square are formed of porous material 2. While the affected areas are described as as being of reduced porosity or being non-porous, it is preferred that they be essentially non-porous, e.g. that liquids do not easily or normally flow through these areas as compared to the flow obtained in the porous areas. Such gridded porous structures are useful in many applications such as in the analysis of microbes in fluids such as water, beverages, pharmaceuticals and other liquids. Likewise, the gridded pattern can serve as “reinforcing structures” to improve the strength or handling characteristics of an otherwise weak unsupported membrane such as an unsupported ultrafiltration membrane or a cellulosic membrane.

An alternative design is shown in FIG. 2, where the one or more porous areas 22 of the porous structure 21 are circular in design and set out in even rows and columns. The area between the porous areas is a reduced porosity or non-porous material 23 formed by the process of the present invention. Such a design is useful in plasmid preparation and other small volume separations.

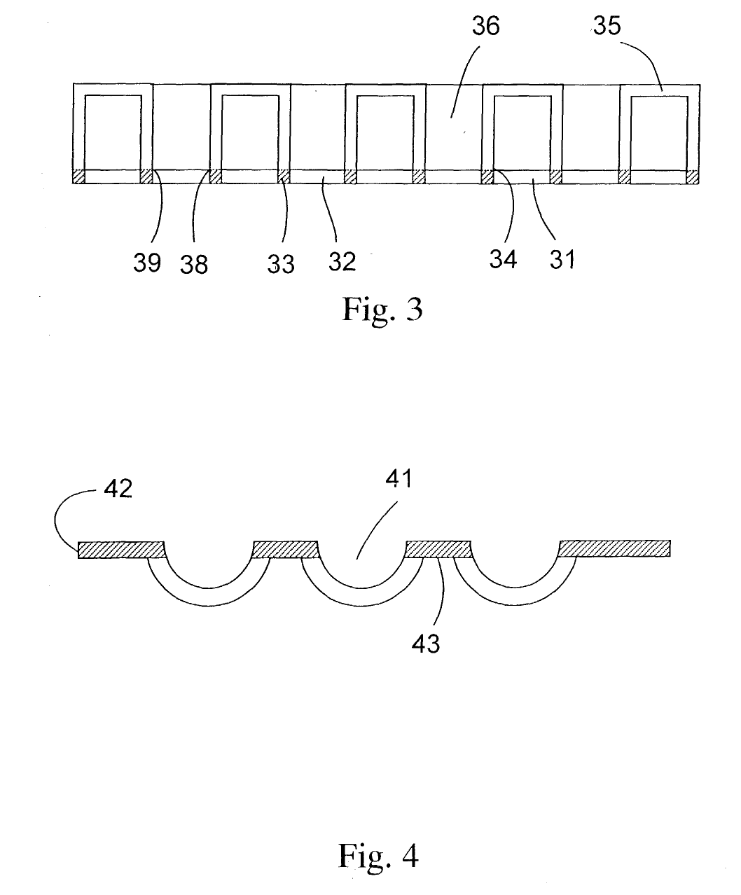

Additionally, this product can then be used in conjunction with a multiple welled device, such as a 96, 384 or higher density well plate, as is shown in FIG. 3. In this Figure, the porous structure 31 of the design of FIG. 2 has been attached to the bottom 34 of a multiple well plate 35 such that one of the porous areas 32 register with one and only one opening 36 of the plate. The reduced porosity or non-porous portion 33 is attached to the land portion 38 of the plate so that a liquid tight seal is formed around the outer periphery 39 of each opening 36 between the plate 35 and the reduced porosity or non-porous portions 33 of the porous structure 31. In this way, a series of separate liquid-tight, sealed, porous wells can be formed in a multiple well device. Additionally, this product allows for the simple attachment of the porous material to the bottom of the open well device. This is something that has in the past been difficult if not impossible to do, especially with UF membranes. The reason being that UF membranes are very delicate and tend to easily collapse even in areas where pressure, heat or softening materials have not been applied. It has been found however that the product of present invention does not suffer from that problem. As such, one can simply heat bond, weld, solvent attach, glue or mechanically attach the patterned porous structure to the well plate without fear of injury to the porous patterns.

In addition, it has been found that the formation of the porous patterns can be carried out such that small 3-dimensional multiple “wells” (concave/convex surfaces) are formed in the porous areas during the collapsing process as shown in FIG. 4. Here the porous areas 41 of the structure 42 are formed into convex/concave forms and are separated from each other by an essentially flat reduced porosity or non-porous areas 43. This device can be formed by the use of openings of a depth and the use of heat, pressure or softening agent sufficient to cause the porous area to slightly flow into the opening so as to form the convex/concave surface. Such a structure can be used as a mini-multiple well device to “hold” drops of liquids in place in the dimpled porous regions. This pattern may be used by itself as shown or in conjunction with a support layer (not shown), such as one or more additional layers of porous structures, a porous plastic sheet or film having openings of size and pattern to coincide to the pattern of porous areas in the structure or it may simply be placed upon a porous or reduced porosity or non-porous support layer with no pattern. In this way, one may obtain a micro-well plate or device that is particularly useful in multiple assays and other small volume template devices and tests.

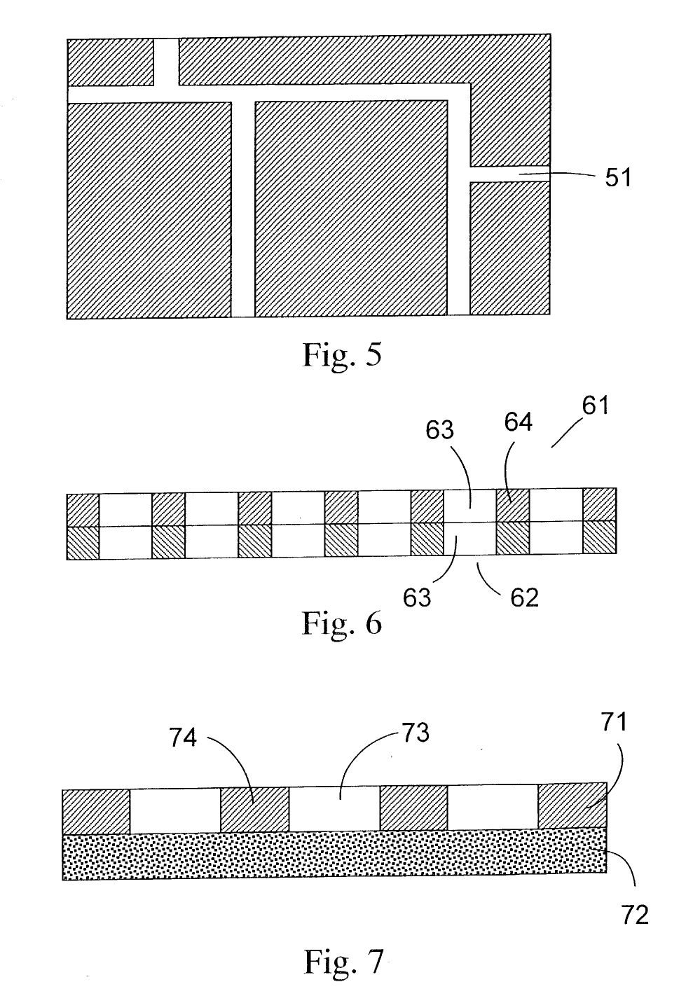

Another form of the present invention can be in a form resembling that of a computer chip. As shown in FIG. 5, the porous porous structure portions 51 can be used as fluid pathways that can be used as a lab-on-a-chip where the pathways are analog to semiconductor integrated circuits. If desired, several layers with different but complementary patterns may be formed together , along with throughholes or vias between the layers to form a multilayered lab-on-a-chip design. Alternatively, such a device can be used in diagnostic devices where the same body fluid such as blood or saliva is then conducted to various regions of and/or at different rates of travel through the structure for different tests. This is helpful in the rapid identification and treatment of diseases and the determination of other conditions such as diabetes or pregnancy or can be used as laboratory on a chip conducting several experiments on one sample and/or its various filtrates.

In FIG. 6 is shown an embodiment in which two or more layers of porous structure and/or porous support material are formed together into a porous/reduced porosity or non-porous area arrangement. As shown in the Figure, there is a porous structure layer 61 and a porous support layer 62. The two are fused together via the heat/pressure/softening agent process of the present invention so as to form a uniform structure having areas of porosity 63 and reduced or non-porosity 64 formed through both layers 61 and 62 and these areas 63 and 64 being in registration with each other. The second layer does not have to serve only as a support but can have other functional benefits to the composite structure such as when an absorbent material is used, it can aid in the removal of an excess liquid from the exposed surface of the porous areas by drawing said liquid through the porous porous structure areas without the need for an external device such as a vacuum pump or a centrifuge to draw the liquid through the porous porous structure areas. Likewise, the additional layers may be as described above, porous structure layers in and of themselves. In this way one can customize the filtration through the structure in a variety of ways. For example, one can select porous structures of different porosities in sequence to obtain a gradient of pore size and thereby filtration. One could also use charged (negative or positive) and uncharged layers as desired or select different layers with known absorptive qualities (such as cellulosic porous structures) or low protein binding to create a unique structure capable of enhanced filtration performance.

Alternatively, one may simply place or bond a structure of the present invention to an adjacent layer(s). The adjacent layer(s) again can be porous structures themselves, more openly porous structures such as nonwoven supports or netting or reduced porosity or non-porous materials. This is shown in FIG. 7 where a porous/reduced porosity or non-porous layer 71 formed as shown in FIG. 2 is laid on top of a porous structure 72, in this case a nonwoven support layer. The porous 73 and reduced porosity or non-porous 74 areas are only in the first layer 71 and do not extend into the other layer 72. The first layer 71 may be simply laid on top of the second layer 72 or it may be held adjacent to it via mechanical means such as by clamps or a frame or it may laminated or adhered to the second layer 72 by heat, pressure, solvents, adhesives welding such as ultrasonic welding, and any other such means which are well-known to one of ordinary skill in the art. As discussed above, the second layer can simply provide a support function or it may play an active part in the structure such as providing a means for drawing liquid through the porous structure areas.

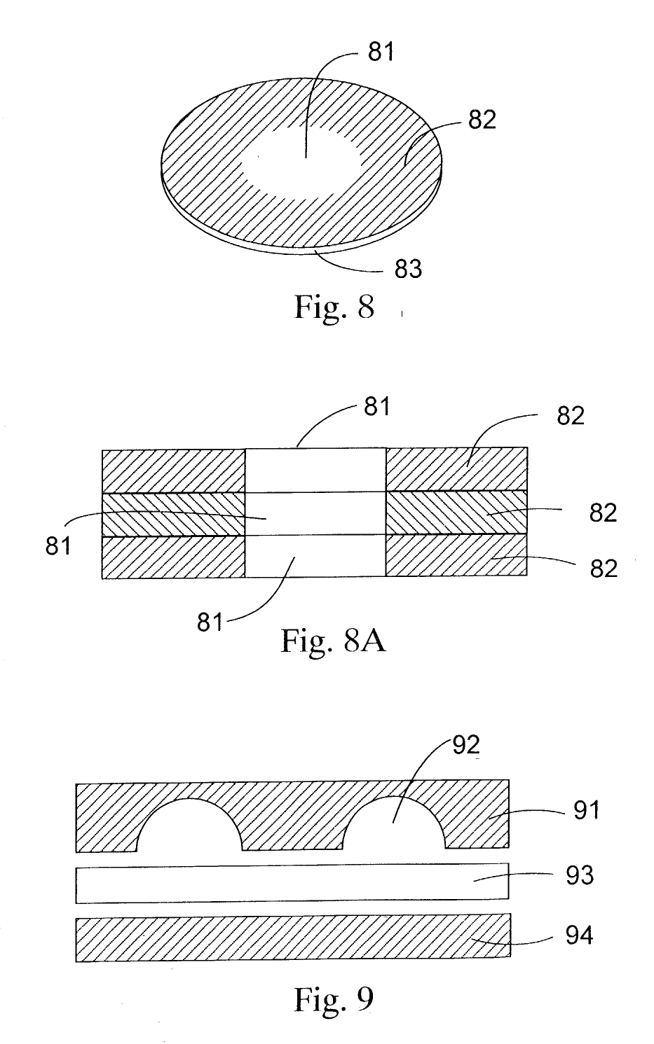

FIG. 8 shows another embodiment of the present invention. In this embodiment, there is only one area of porous material 81 and one area of reduced porosity or non-porous material 82 in the porous structure 83. As shown in the Figure, the porous area 81 is surrounded by the reduced porosity or non-porous area 82. Other arrangements may be used as well such as more than one area of porous material surrounded by one continuous area of reduced porosity or non-porous material or vice versa.

Additionally, as shown in FIG. 8A, multiple layers of porous materials and/or support materials such as netting or nonwoven support material may be used to create a multilayered structure of the design of FIG. 8. The structure can simply be formed simultaneously by stacking the desired layers together and forming the porous/reduced porosity or non-porous structure. Alternatively, as discussed above the layers can be made individually and then formed together in to a unified structure. The layers may be the same or different materials, the choice being up to the designer and the parameters within which he/she is working. They may also be formed of the same or different diameters of active area. For example, it may be desired to form a structure having a narrowing or increasing diameter as one travels through the structure from one side to the other.

Additionally, although the embodiments of FIGS. 8 and 8A are shown as being circular, they are not limited to that shape. Any shape which accomplished the desired effect can be used, including triangular, rectangular, octagonal and other polygonal as well as regular and irregular shapes.

The particular design shown in FIGS. 8 and 8A is of value in allowing one to use a structure of one given size, yet the area of active porosity may be widely varied. For example, there are several standard sized membranes used in various standardized tests, typically circular membranes having a diameter of 25 mm, 37 mm or 47 mm. A supplier must have on inventory a supply of each size membrane in each type of membrane material that is used along with a supply of the various sized holders for these membranes during the tests. Using a membrane of the design shown in FIGS. 8 and 8A, one can simply maintain a stock of the largest membrane size (typically 47 mm diameter) and use the process of present invention to reduce the active porous area to the smaller required size as needed by the customer. This reduces the amount of inventory of different sized membranes and holders that is required to be maintained.

The porous/reduced porosity or non-porous structure of the present invention may also be used in injection molded devices. The reduced porosity or non-porous areas can be arranged in a configuration that coincides with the areas in contact with the injection molding material. This isolates the porous material from the injection molding material and the heat associated with the application of that material allowing for one to make an injection molded device with an integral porous structure as one component of that device.

Other uses and the incorporation of a porous/reduced porosity or non-porous structure of present invention will be obvious to one of ordinary skill in the art.

The method of forming the structure of the present invention is to use either heat, pressure or a combination of both to selectively collapse porous areas of a porous structure so as to form the porous/reduced porosity or non-porous structure of the present invention. The selection of heat, pressure or both is determined by the porous structure material and the desires of the designer. All three will work and provide the desired product. It is preferred with polymeric materials to use a combination of heat and pressure in forming the device. However in porous materials which are highly temperature sensitive, use of pressure alone may be more appropriate.

A softening chemical may be used to assist in the collapse, such as a properly chosen solvent, or mixture of solvent and non-solvent or partial solvent for the polymeric porous structure, which will hasten the collapse of the porous region when pressure is applied. In some cases, for example, thin sheets, mere application of the softening chemical during collapse may be sufficient to collapse the porous regions to form the patterns without the need for using heat. When using 3 softening chemical, the porous structure can be contacted with the softening chemical prior to being collapsed. The nature of the softening chemical will vary depending on the porous structure polymer but it can be water, alcohols such as t-butyl alcohol, glycerol, halogenated solvents such as chloroform, polar aprotic solvents such as N-methyl pyrrolidone, dimethylformamide, aromatic solvents such as toluene or mixtures thereof.

In a typical method for making the present invention, one determines which process one will use and then forms a template in the desired shape and pattern for the desired product. For example, one may decide to form a porous/reduced porosity or non-porous structure having a series of circular porous areas arranged in rows and columns (similar to that of FIG. 2). A setup for making the product of present invention is shown in FIG. 9. One simply makes a template 91 with a series of openings 92 that correspond in size and arrangement to the desired series of porous areas for the structure. Gridded structures may be formed by forming a template-like template, a screen or using a simple straight edge device and applying it sequentially to the various areas of the structure 93 in order to form the desired gridded arrangement. The device of FIG. 8 can be formed by forming an opening in the template 91 which has a diameter corresponding to that of the desired size (e.g. 25 mm or 37 mm, etc.). Other arrangements can easily be made by one of ordinary skill in the art.

The template 91 is then placed against the porous structure 93 and a choice of pressure, heat, softening chemical or the combination of any of the three is applied to the structure 93 for a period of time sufficient to form the desired pattern in the structure 93. Typically, the structure is backed by an adjacent surface 94,that is preferably flat, although it doesn't need to be, against which the template 91 is applied. Alternatively, the adjacent surface 94 may also contain a pattern that can be complimentary to that of the template 91 or not. When using a softening chemical, it can also be applied to the template 91. For example, the solid portion of the template 95 that contacts the structure 93 can be coated with said softening chemical prior to collapsing the selected areas of the structure 93.

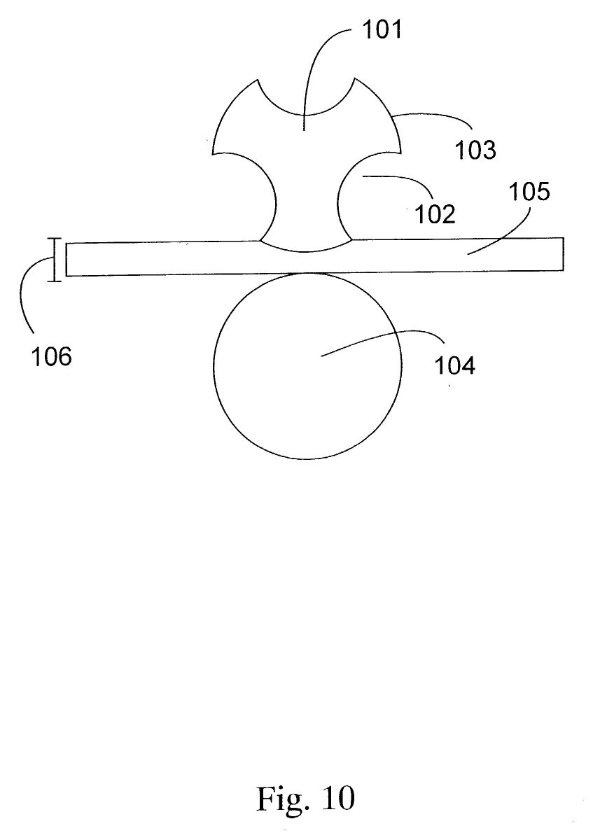

Alternatively, the process may be carried out in a continuous manner using one or more rollers or belts or other similar devices which can apply a select repeated pattern to a length of porous material either on one or both sides as desired. In such an embodiment, one simply uses a roller such as an embossing roller and runs a length of porous material between the roller and a non-embossed surface, such as a flat surface or a non-embossed or smooth roller. Alternatively, the adjacent surface may also contain a patterned surface if desired. The device used for forming the continuous pattern may be formed of metal or rubber, the material of choice depending upon the ability to form adequate patterns in the structure. Heat, pressure, softening agent or a combination of any of the three may be applied through the device or its adjacent non-embossed surface or both. FIG. 10 shows one embodiment of a continuous process. A first roller 101 contains a series of depressions or openings 102 in its outer surface 103 that correspond to the desired porous pattern. An adjacent roller 104 is also used. In this embodiment it is shown as a smooth roller although it may also contain a series of depressions or openings in its outer surface if one so desires. A length of porous structure material 105 is passed between the two rolls 101 and 104 and the pattern is formed in the structure 105. One may vary the gap 106 between the two roller surfaces so as to allow for the suitable formation of the desired pattern. Depending upon the choice of pattern formation, one may vary the gap accordingly. Additionally, where heat is used as one or the sole means for forming the pattern, one may use a heating roller either as one of the two rollers and/or as a roller before entering the pattern-making device so as to preheat the structure to the desired temperature.

When using heat, one should select a temperature which is sufficient to cause the pores in the selected areas to collapse but not to cause the pores is the others areas to collapse. The specific temperature is dependent upon the polymer used. However, the temperature should be from well before the structure begins to deform to the melting point of the structure. Alternatively, one can use a temperature from about 25° C. to about 500° C., preferably from about 25° C. to about 300° C. and more preferably from about 50° C. to about 200° C. for a time sufficient to cause collapse of the porous structure. The time can vary depending on the temperature used but can be in the range of about 1 second to 60 minutes, preferably between about 1 seconds and about 30 minutes and more preferably between about 2 seconds and about 10 minutes.

When using pressure, alone or in combination with heat or a softening chemical, one should use sufficient pressure to cause the collapse of the pores in the selected area without adversely affecting the pores in the other areas. The amount of pressure used can vary depending on the amount of surface area to be collapsed, time, temperature and softening chemical but one can typically use from about 10 psi to about 500,000 psi. Preferably from about 100 psi to about 100,000 psi and most preferably from about 500 psi to about 50,000 psi.

The template can be made of a material normally used in pressure or heating applications. Metals such as stainless steel or aluminum are preferred especially for the heat or heat/pressure applications as they easily conduct heat. Various plastics such PTFE, polyethylene, especially ultrahigh molecular weight polyethylene (UPE), polypropylene or epoxies can be used to make templates as well. Other materials such as fiberglass or carbon composites, various rubbers such as EPDM or butyl rubber, even wood can be used to make templates. All that is required is that the material have sufficient strength and/or heat resistance to withstand the use. The template may also have a non-stick surface such as a PTFE coating in order to ensure easy removal of the formed structure from the template.

The product of the present invention and the process by which it is made can be applied to any porous membrane that is subject to collapse. Preferably, it is of particular use with any polymeric porous membrane of any pore size, such as reverse osmosis, ultrafiltration, microfiltration, macrofiltration, any configuration such as symmetrical or asymmetrical, skinned or unskinned and made by any process such as casting, extrusion, track etching, sintering, stretching and other such well-known methods. Additionally, the process may be used on woven and nonwoven fabric which provide a filtration function.

The polymeric material which forms the preferred porous porous structure that may be used to form the product of the present invention is not limited as occurred with the prior art products and processes for forming patterned membranes. For example, one is not limited to materials that form gelled structures in the presence of a solvent. This means one can use materials that are difficult if not impossible to solvate due to the lack of appropriate solvents for the material, such as PTFE resin. Additionally one may use UV absorbent polymers such as polyethersulphone that was not possible with the known prior art techniques. These polymers can include semicrystalline or amorphous polymers, hydrophilic polymers or hydrophobic polymers. They may be thermoplastic, which are preferred or thermoset.

Preferred polymers include but are not limited to polyolefins such as polyethylene, including ultrahigh molecular weight polyethylene, polypropylene and various polyolefin copolymers and terpolymers, PTFE resin and thermoplastic perfluoropolymers such as PFA, PVDF, polyamides, polyimides, polyethersulphones, polysulphones, polyarylsulphones, PVC, PET, polycarbonates, cellulose, cellulose esters such as cellulose acetate or cellulose nitrate, polystyrenes, polyetherimides, acrylic polymers, methacrylic polymers, copolymers of acrylic or methacrylic polymers, various thermoset materials such as epoxy, epoxy filled materials and polyurethanes, or blends of any of the above and the like.

Support structures which can be used in association with the patterned structure of the present invention can be any of the above polymers as well as glass, cotton or other fibrous products, typically in the form of a scrim, woven fabric or nonwoven, as well as non-porous sheets.

The selected porous structures may be surface modified either before or after the pattern formation so as to provide a specific surface characteristic such as hydrophilicity, hydrophobicity, charge, affinity ligands and the like.

The shape of the porous structure can be any which is useful such as the traditional round or rectangular shaped porous structures, although other shapes can be used.

Likewise, filled porous structures may also be used in this process. Such porous structures are well known in the art and typically contain ion exchange resins or chromatography media embedded in the matrix of the porous structure. One such material is sold by 3M of Minneapolis, Minn. under the name of Empore® membranes.

### EXAMPLE 1

A patterned porous/reduced porosity or non-porous ultrahigh molecular weight polyethylene (UPE) membrane was made according to the teachings of the present invention. A 0.1 microns UPE membrane available from Millipore Corporation of Bedford, Mass. was placed into a hydraulic press. A flat metal template having circular voids of about 2 mm diameter spaced about 3 mm apart (measured from center to center) was placed on top of the membrane and a flat metal plate having a smooth surface was placed under the membrane and the press was closed and operated at about 24,000 psi over a rectangular area 6 inches by 12 inches and heated to a temperature of about 110° C. for 2 minutes.

The membrane was removed from the press and examined. Portions of the membrane were collapsed in the areas where the membrane contacted the metal of the template. A pattern of porous circular portions of membrane corresponding to the voids in the template were clearly shown and remained.

### EXAMPLE 2

A hydrophilic surface modified polyvinylidene fluoride membrane, available from Millipore Corporation of Bedford, Mass.) of 3.0 inches by 4.5 inches, having a porosity of about 80 percent, with average pore size of 0.45 microns, was formed into a patterned structure according to the present invention.

A template of 2.75 inches by 4.25 inches was made of steel and a series of 384 equally spaced circular openings (0.125 inch in diameter) was formed in the template in an arrangement of 16 rows of 24 openings. The template was attached to the a heat source of a Carver laboratory hydraulic press obtained from Fred S. Carver, Inc, of Menomonee, Wis. The template was heated to 180° C. and the membrane was placed between the template and a flat metal plate having a smooth surface heated to 160° C. The membrane, sandwiched between the template and the metal plate was placed in the press and the press was activated at 22,000 psi for 10 seconds. The template was then removed and the membrane was cooled.

384 equally spaced circular dots corresponding to the openings of the template were formed in the membrane and found to have remained porous and hydrophilic while the area of membrane surrounding the dots were substantially of reduced porosity or non-porous. Additionally, it was found that the surfaces of the dots were concave on one surface while being convex on the other. This allowed for the formation of 384, discrete, isolated porous wells that are suitable for a variety of analytical and laboratory uses.

### EXAMPLE 3

A patterned porous/reduced porosity or non-porous polytetrafluoroethylene (PTFE) membrane was made according to the teachings of the present invention. A 0.1 micron PTFE membrane available from Millipore Corporation of Bedford, Mass. was placed on topa flat piece of polished stainless steel having a smooth surface. A flat stainless screen having circular voids about 76 microns in diameter spaced about 150 microns apart (measured center to center) was placed on top of the membrane. A second flat piece of polished stainless steel having a smooth surface was placed on top of the screen to form a sandwich. The sandwich was then placed in the jaws of a pair of pliers, closed and pressed by hand for about 30 seconds at room temperature.

The membrane was removed from the sandwich and examined. Portions of the membrane were collapsed and rendered substantially non-porous in the areas where the membrane contacted the metal of the screen. A pattern of porous circular portions corresponding to the voids in the screen were clearly formed and remained.

Other embodiments, derivatives and modifications of the present invention will be obvious to one of ordinary skill in the art and is meant by the present invention to be included within the scope of the present invention.

What is claimed:

1) A process for forming a pattern of porous and reduced porosity areas on a porous structure comprising the steps of: selecting one or more layers of a porous structure, forming a pattern template having a solid matrix containing one or more openings, said one or more openings being arranged in the solid matrix to form the selected pattern for the areas of porous and reduced porosity, contacting the template to a selected surface of the porous structure and applying an energy selected from the group consisting of heat, pressure, softening and combinations thereof to the areas of the structure aligned with the solid matrix in the template in order to cause the porous structure beneath the solid matrix of the template to collapse and become fused into a reduced porosity mass.

2) A patterned porous structure comprising one or more layers of a porous structure having one or more areas of porous material and one or more areas of reduced porosity or non-porous material.

3) The patterned structure of claim 2 wherein the one or more areas of porous material are more than one in number and are arranged in a manner so as to be separate and distinct from each other and separated from each other by a reduced porosity or non-porous structure.

4) The patterned structure of claim 2 wherein the one or more areas of porous material are of a shape selected from the group consisting of circles, ovals, polygons, lines, and mixtures thereof.

5) The patterned structure of claim 2 wherein the one or more porous areas are 96 in number and are equal in size.

6) The patterned structure of claim 2 wherein the one or more areas are at least 96 in number, equal in size and arranged in rows relative to each other in both the X and Y direction.

7) The patterned structure of claim 2 wherein the one or more areas are at least 384 in number.

8) A process for forming a pattern of porous and reduced porosity or non-porous areas on a porous structure comprising the steps of: selecting a porous structure, forming a pattern template containing the selected pattern for the areas of porous and reduced porosity or non-porous areas, said template having a series of openings which corresponding to the porous areas, contacting the template to a surface of the porous structure and applying a energy selected from the group consisting of heat, pressure, softening agents and combinations thereof to the areas of the structure not aligned with the openings in the template in order to cause the porous structure beneath the area of the template not aligned with the openings of the template to collapse and to become fused into a reduced porosity or non-porous mass.

9) The patterned structure of claim 2 wherein the porous structure is formed of two or more layers.

10) The patterned structure of claim 2 wherein the porous structure is formed of two or more layers and each of the layers have one or more areas of porous material and one or more areas of reduced porosity material formed therein.

11) The patterned structure of claim 2 wherein the porous structure is formed of two or more layers and each of the layers have one or more areas of porous material and one or more areas of reduced porosity material formed therein and wherein the reduced porosity areas are non-porous.

12) The patterned structure of claim 2 wherein the porous structure is formed of two or more layers and less than all of the layers have one or more areas of porous material and one or more areas of reduced porosity material formed therein and in register with each other.

13) The patterned structure of claim 2 wherein the porous structure is formed of two or more layers and each of the layers have one or more areas of porous material and one or more areas of reduced porosity material formed therein and the areas of porous and reduced porosity material vary from layer to layer.

14) The patterned structure of claim 2 wherein the porous structure is formed of two or more layers and at least one of the one or more layers have one or more areas of porous material and one or more areas of reduced porosity material formed therein.

15) The patterned structure of claim 2 wherein the porous structure is formed of two or more layers, at least one of the layers has one or more areas of porous material and one or more areas of reduced porosity material formed therein and wherein the two or more layers are selected from the group consisting of porous membranes, porous support materials and blends thereof.

16) The patterned structure of claim 2 wherein the porous structure is formed of two or more layers, at least one of the layers has one or more areas of porous material and one or more areas of reduced porosity material formed therein and wherein at least one layer is a porous membrane and the remaining layer(s) are selected from the group consisting of porous membranes, porous support materials, reduced porosity or non-porous materials and blends thereof.

17) The patterned structure of claim 2 wherein the porous structure is formed of two or more layers and each of the layers having formed therein one area of porous material surrounded by one area of reduced porosity material along an outer periphery of the porous material.

18) The patterned structure of claim 2 wherein the porous structure is formed of two or more layers, each of the layers having formed therein one area of porous material surrounded by one area of reduced porosity material along an outer periphery of the of the porous material and the porous material being in a shape selected from the group consisting of circles, ovals, triangles, rectangles, squares and polygons.

19) The patterned structure of claim 2 wherein the porous structure is formed of two or more layers of porous membranes and each of the layers having formed therein one area of porous material surrounded by one area of reduced porosity material along an outer periphery of the porous material and wherein the reduced porosity material is non-porous.

20) The patterned structure of claim 2 wherein the porous structure is formed of two or more layers of porous structures, each of the layers having formed therein one area of porous material surrounded by one area of reduced porosity material along an outer periphery of the porous material and the porous structures are formed of a materials selected from the group consisting of polyolefins, polyolefin copolymers and terpolymers, PTFE resin, thermoplastic perfluoropolymers, polyamides, polyimides, PVDF, polyethersulphones, polysulphones, polyarylsulphones, PVC, PET, polycarbonates, cellulose, cellulose esters, cellulose acetate, cellulose nitrate, polystyrenes, polyetherimides, acrylic polymers, methacrylic polymers, copolymers of acrylic or methacrylic polymers, epoxies, epoxy filled materials, polyurethanes and blends of any of the above.

21) The patterned structure of claim 2 wherein the porous structure is formed selected from the group consisting of polyolefins, polyolefin copolymers and terpolymers ,PVDF, PTFE resin, thermoplastic perfluoropolymers, polyamides, polyimides, polyethersulphones, polysulphones, polyarylsulphones, PVC, PET, polycarbonates, cellulose, cellulose esters, cellulose acetate, cellulose nitrate, polystyrenes, polyetherimides, acrylic polymers, methacrylic polymers, copolymers of acrylic or methacrylic polymers, epoxies, epoxy filled materials, polyurethanes and blends of any of the above.

22) The patterned structure of claim 2 wherein the porous structure is surfaced modified before the formation of the porous and reduced porosity areas.

23) The patterned structure of claim 2 wherein the porous structure is surfaced modified after the formation of the porous and reduced porosity areas.

24) The patterned structure of claim 2 wherein the surface modification is selected from the group consisting of hydrophilic coatings, hydrophobic coatings, negatively charged coatings and positively charged coatings.
